(19) United States
(12) Patent Application Publication
(10) Pub. No.: US 2022/0190897 A1
(43) Pub. Date: Jun. 16, 2022

(54) CODEBOOK FOR DISTRIBUTED MIMO TRANSMISSION

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 17/542,298

(22) Filed: Dec. 3, 2021

Related U.S. Application Data
(60) Provisional application No. 63/125,192, filed on Dec. 14, 2020.
(60) Provisional application No. 63/126,735, filed on Dec. 17, 2020.
(60) Provisional application No. 63/273,565, filed on Oct. 29, 2021.

(51) Int. Cl. H04B 7/06

(52) U.S. Cl. CPC H04B 7/0626; H04B 7/0639

(57) ABSTRACT

A method for operating a user equipment (UE) comprises receiving information about a channel state information (C SI) report, the information including a number N_{RRH}>1 and RRH r, wherein: N_{RRH}=number of remote radio heads (RRHs), RRH r comprises a group of P channel state information reference signal (C SIRS) antenna ports, and r=1, . . . , N_{RRH}; selecting a strongest RRH from the N_{RRH} RRHs; determining the CSI report including an indicator indicating the strongest RRH; and transmitting the CSI report including the indicator indicating the strongest RRH.

### CROSS-REFERENCE TO RELATED APPLICATIONS AND CLAIM OF PRIORITY

The present application claims priority to U.S. Provisional Patent Application No. 63/125,192, filed on Dec. 14, 2020; U.S. Provisional Patent Application No. 63/126,735, filed on Dec. 17, 2020; and U.S. Provisional Patent Application No. 63/273,565, filed on Oct. 29, 2021. The content of the above-identified patent documents is incorporated herein by reference.

### TECHNICAL FIELD

The present disclosure relates generally to wireless communication systems and more specifically to CSI reporting based on a codebook for distributed MIMO transmission.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE.

### SUMMARY

Embodiments of the present disclosure provide methods and apparatuses to enable channel state information (CSI) reporting based on a codebook for distributed MIMO transmission in a wireless communication system.

In one embodiment, a UE for CSI reporting in a wireless communication system is provided. The UE includes a transceiver configured to receive information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (CSIRS) antenna ports, and r=1, . . . , N_{RRH}. The UE further includes a processor operably connected to the transceiver. The processor, based on the information, is configured to: select a strongest RRH from the N_{RRH} RRHs; and determine the CSI report including an indicator indicating the strongest RRH. The transceiver is further configured to transmit the CSI report including the indicator indicating the strongest RRH.

In another embodiment, a BS in a wireless communication system is provided. The BS includes a processor configured to generate information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (C SIRS) antenna ports, and r=1, . . . , N_{RRH}. The BS further includes a transceiver operably connected to the processor. The transceiver is configured to: transmit the information; and receive the CSI report, wherein the CSI report includes an indicator indicating a strongest RRH selected from the N_{RRH} RRHs.

In yet another embodiment, a method for operating a UE is provided. The method comprises: receiving information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (C SIRS) antenna ports, and r=1, . . . , N_{RRH}; selecting a strongest RRH from the N_{RRH} RRHs; determining the CSI report including an indicator indicating the strongest RRH; and transmitting the CSI report including the indicator indicating the strongest RRH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates an example distributed MIMO (D-MIMO) system according to embodiments of the present disclosure;

FIG. 11 illustrates an example antenna port layout according to embodiments of the present disclosure;

FIG. 12 illustrates an example of Type I single panel (SP) and Type I multi-panel (MP) codebook based MIMO transmission according to embodiments of the present disclosure;

FIG. 13 illustrates an example D-MIMO where each RRH has a single antenna panel according to embodiments of the present disclosure;

FIG. 14 illustrates an example D-MIMO where each RRH has multiple antenna panels according to embodiments of the present disclosure;

FIG. 15 illustrates an example D-MIMO where each RRH can have a single antenna panel or multiple antenna panels according to embodiments of the present disclosure;

FIG. 16 illustrates a flow chart of a method for operating a UE according to embodiments of the present disclosure; and

FIG. 17 illustrates a flow chart of a method for operating a BS according to embodiments of the present disclosure.

### DETAILED DESCRIPTION

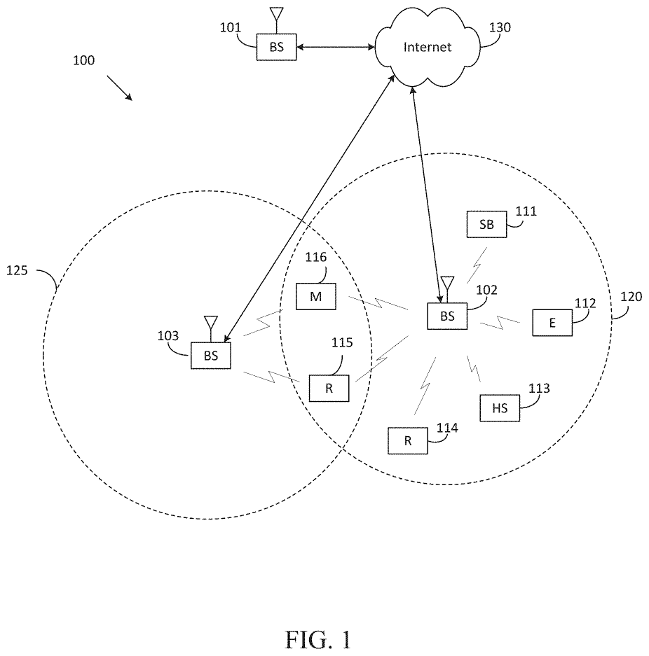

FIGS. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v16.6.0, “E-UTRA, Physical channels and modulation” (herein “REF 1”); 3GPP TS 36.212 v16.6.0, “E-UTRA, Multiplexing and Channel coding” (herein “REF 2”); 3GPP TS 36.213 v16.6.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.6.0, “E-UTRA, Radio Resource Control (RRC) protocol specification” (herein “REF 5”); 3GPP TR 22.891 v14.2.0 (herein “REF 6”); 3GPP TS 38.212 v16.6.0, “E-UTRA, NR, Multiplexing and channel coding” (herein “REF 7”); and 3GPP TS 38.214 v16.6.0, “E-UTRA, NR, Physical layer procedures for data” (herein “REF 8”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another, or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (CSIRS) antenna ports, and r=1, . . . , N_{RRH}; selecting a strongest RRH from the N_{RRH} RRHs; determining the CSI report including an indicator indicating the strongest RRH; and transmitting the CSI report including the indicator indicating the strongest RRH. One or more of the gNBs 101-103 includes circuitry, programing, or a combination thereof, for generating information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (C SIRS) antenna ports, and r=1, . . . , N_{RRH}; transmitting the information; and receiving the CSI report, wherein the CSI report includes an indicator indicating a strongest RRH selected from the N_{RRH} RRHs.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

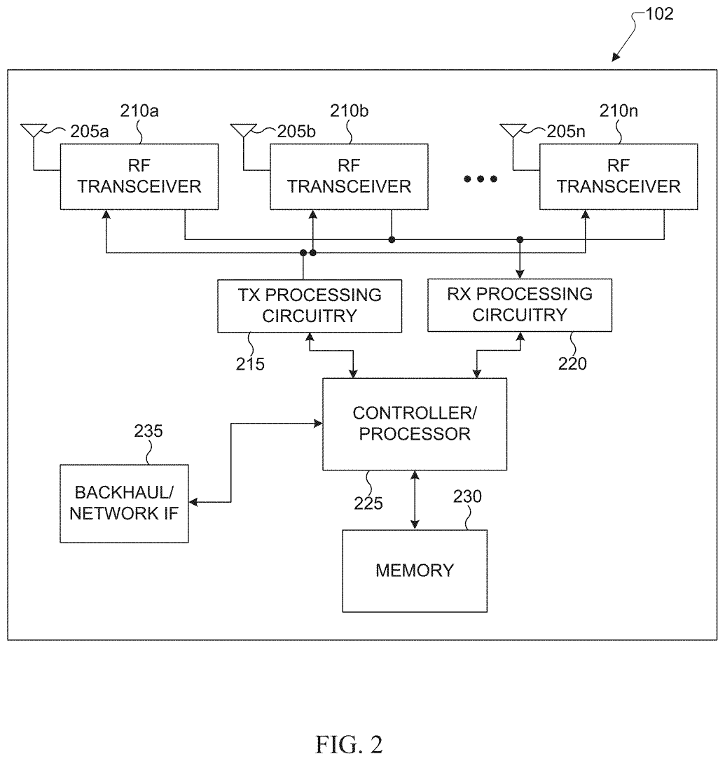

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

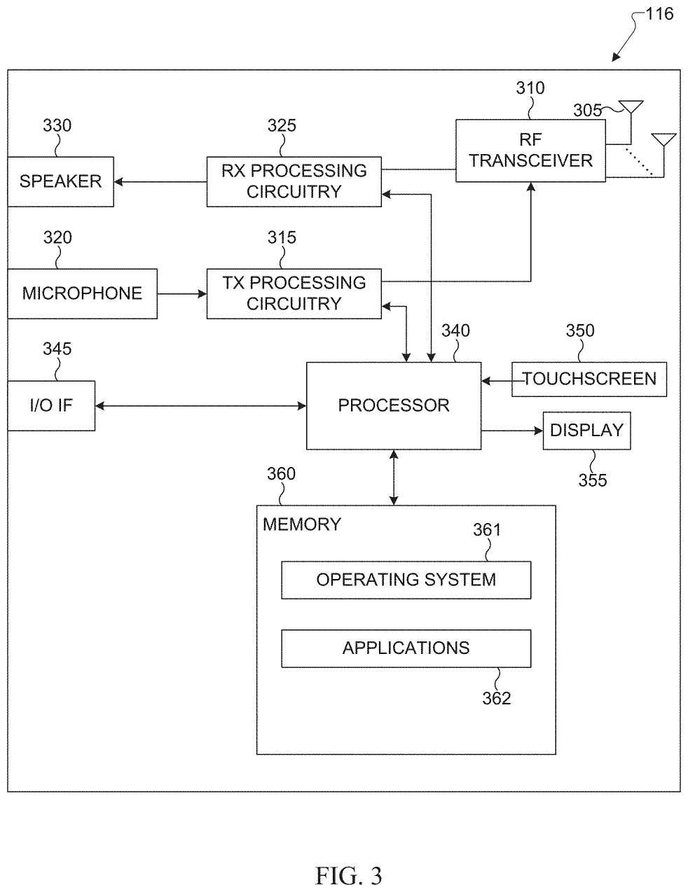

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (CSIRS) antenna ports, and r=1, . . . , N_{RRH}; selecting a strongest RRH from the N_{RRH} RRHs; determining the CSI report including an indicator indicating the strongest RRH; and transmitting the CSI report including the indicator indicating the strongest RRH. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

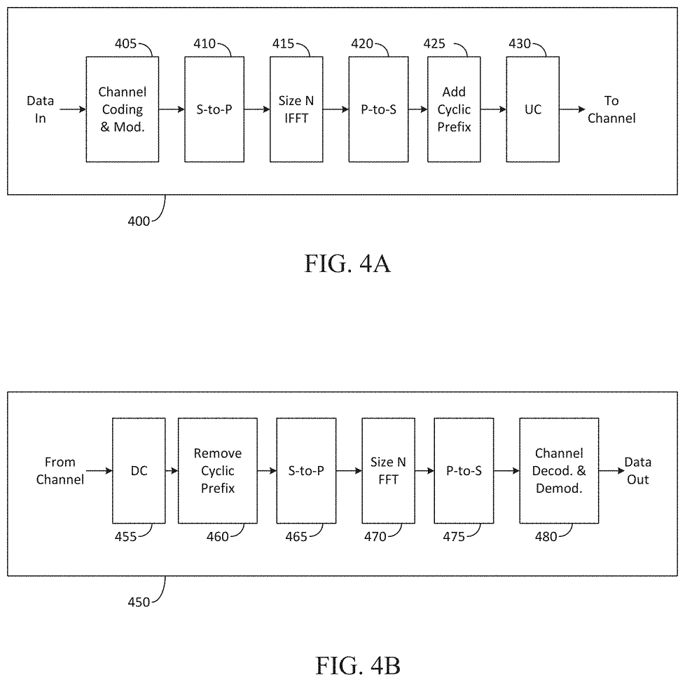

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460, and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe symbol can be used to multiplex SRS transmissions from one or more UEs. A number of subframe symbols that are available for data/UCl/DMRS transmission is N_{symb}=2·(N_{symb}^{UL}−1)−N_{SRS}, where N_{SRS}=1 if a last subframe symbol is used to transmit SRS and N_{SRS}=0 otherwise.

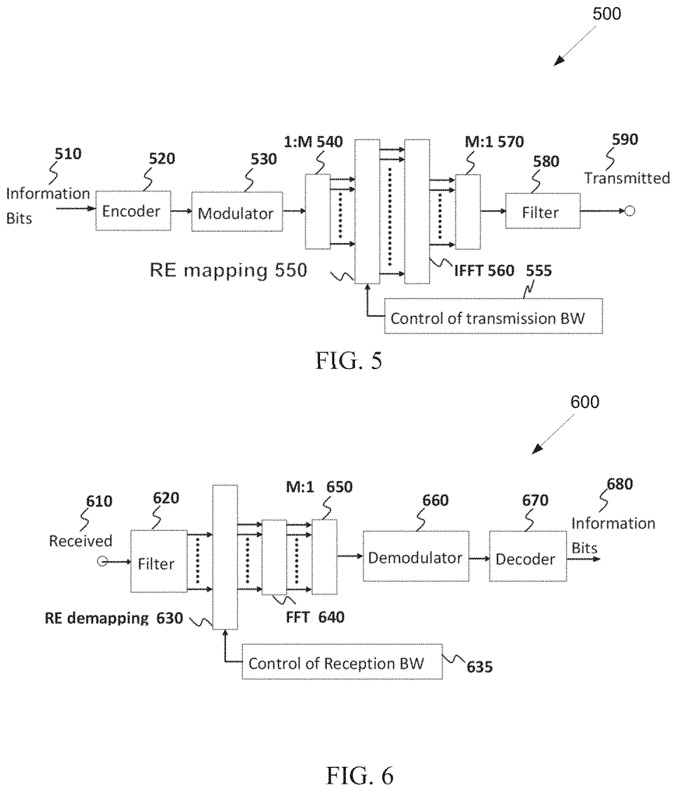

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

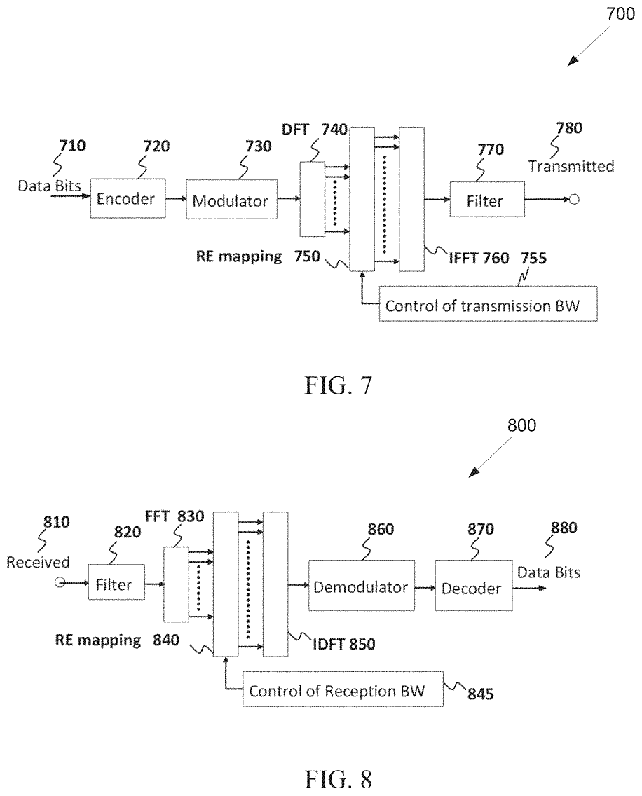

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

In next generation cellular systems, various use cases are envisioned beyond the capabilities of LTE system. Termed 5G or the fifth generation cellular system, a system capable of operating at sub-6 GHz and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km² with less stringent the reliability, data rate, and latency requirements.

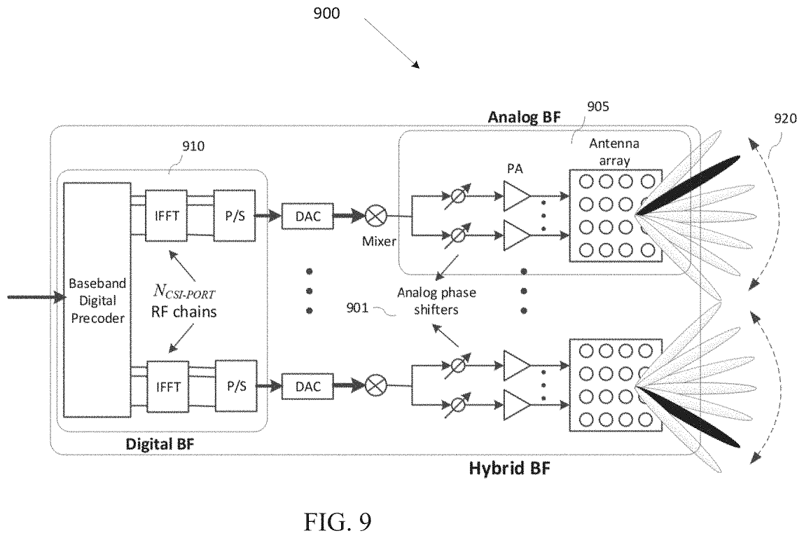

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported, for example, “CLASS A” CSI reporting which corresponds to non-precoded CSI-RS, “CLASS B” reporting with K=1 CSI-RS resource which corresponds to UE-specific beamformed CSI-RS, and “CLASS B” reporting with K>1 CSI-RS resources which corresponds to cell-specific beamformed CSI-RS.

For non-precoded (NP) CSI-RS, a cell-specific one-to-one mapping between CSI-RS port and TXRU is utilized. Different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (e.g., comprising multiple ports). At least at a given time/frequency, CSI-RS ports have narrow beam widths and hence not cell wide coverage, and at least from the gNB perspective. At least some CSI-RS port-resource combinations have different beam directions.

In scenarios where DL long-term channel statistics can be measured through UL signals at a serving eNodeB, UE-specific BF CSI-RS can be readily used. This is typically feasible when UL-DL duplex distance is sufficiently small. When this condition does not hold, however, some UE feedback is necessary for the eNodeB to obtain an estimate of DL long-term channel statistics (or any of representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, it can be acquired using the CSI-RS transmission from eNB (or gNB), and CSI acquisition and feedback from UE. In legacy FDD systems, the CSI feedback framework is ‘implicit’ in the form of CQI/PMI/RI (also CRI and LI) derived from a codebook assuming SU transmission from eNB (or gNB). Because of the inherent SU assumption while deriving CSI, this implicit CSI feedback is inadequate for MU transmission. Since future (e.g., NR) systems are likely to be more MU-centric, this SU-MU CSI mismatch will be a bottleneck in achieving high MU performance gains. Another issue with implicit feedback is the scalability with larger number of antenna ports at eNB (or gNB). For large number of antenna ports, the codebook design for implicit feedback is quite complicated (for example, a total number of 44 Class A codebooks in the 3GPP LTE specification), and the designed codebook is not guaranteed to bring justifiable performance benefits in practical deployment scenarios (for example, only a small percentage gain can be shown at the most). Realizing aforementioned issues, the 3GPP specification also supports advanced CSI reporting in LTE.

In 5G or NR systems [REFI, REF8], the above-mentioned “implicit” CSI reporting paradigm from LTE is also supported and referred to as Type I CSI reporting. In addition, a high-resolution CSI reporting, referred to as Type II CSI reporting, is also supported to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

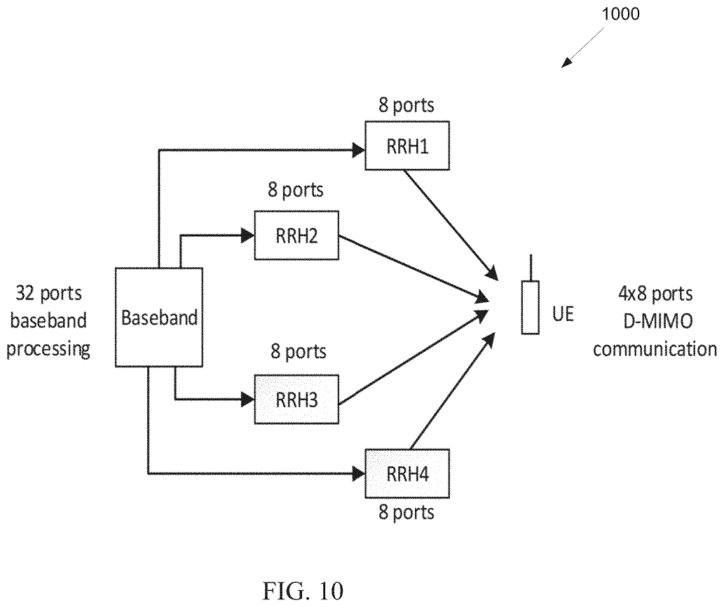

FIG. 10 illustrates an example distributed MIMO (D-MIMO) system 1000 according to embodiments of the present disclosure. The embodiment of the distributed MIMO (D-MIMO) system 1000 illustrated in FIG. 10 is for illustration only. FIG. 10 does not limit the scope of this disclosure to any particular implementation of the distributed MIMO (D-MIMO) system 1000.

NR supports up to 32 CSI-RS antenna ports. For a cellular system operating in a sub-1GHz frequency range (e.g., less than 1 GHz), supporting a large number of CSI-RS antenna ports (e.g., 32) at one site or remote radio head (RRH) is challenging due to larger antenna form factors at these frequencies (when compared with a system operating at a higher frequency such as 2 GHz or 4 GHz). At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) can't be achieved. One way to operate a sub-1 GHz system with large number of CSI-RS antenna ports is based on distributing antenna ports at multiple sites (or RRHs). The multiple sites or RRHs can still be connected to a single (common) baseband unit, hence the signal transmitted/received via multiple distributed RRHs can still be processed at a centralized location. For example, 32 CSI-RS ports can be distributed across 4 RRHs, each with 8 antenna ports. Such a MIMO system can be referred to as a distributed MIMO (D-MIMO) system as illustrated in FIG. 10.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

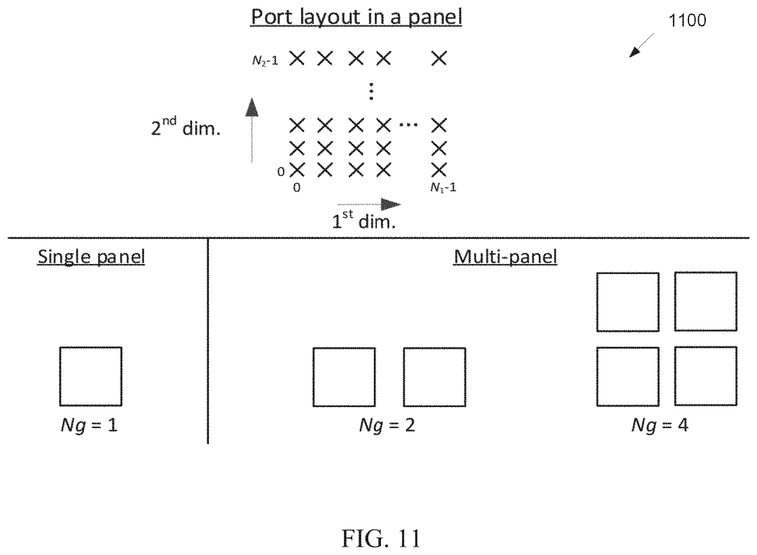

FIG. 11 illustrates an example antenna port layout 1100 according to embodiments of the present disclosure. The embodiment of the antenna port layout 1100 illustrated in FIG. 11 is for illustration only. FIG. 11 does not limit the scope of this disclosure to any particular implementation of the antenna port layout 1100.

As illustrated in FIGS. 11, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 11 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-Rs antenna ports and X is a starting antenna port number (e.g., X=3000, then antenna ports are 3000, 3001, 3002, . . . ).

Let N₉ be a number of antenna panels at the gNB. When there are multiple antenna panels (N_{g}>1), we assume that each panel is dual-polarized antenna ports with N₁ and N₂ ports in two dimensions. This is illustrated in FIG. 11. Note that the antenna port layouts may or may not be the same in different antenna panels.

As described in Section 5.2.2.2.1 of [REF 8], the Type I single-panel codebook has the following rank 1 (1-layer) pre-coder structure:

$${W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ]$$

where P_{CSI-RS}=2N₁N₂ is a number of CSI-RS antenna ports, ϕₙ=e^{jπn/2} is a co-phase value across two antenna polarizations, and

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix} \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

is a two-dimensional DFT vector. The supported values of n is {0,1,2,3}, which corresponds to QPSK co-phase {1, j, −1, −j}. The supported values of (N₁, N₂, O₁, O₂) is given by Table 1.

TABLE 1
Supported configurations of (N₁, N₂) and (O₁, O₂)

| Number of CSI-RS | | |
|---|---|---|
| antenna ports, P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

As described in Section 5.2.2.2.2 of [REF 8], the Type I multi-panel codebook has the following rank 1 (1-layer) pre-coder structure for codebookMode=1:

$${W}_{l , m , p , n}^{( 1 )} = {W}_{l , m , p , n}^{1 , {N}_{g} , 1}$$

$$where$$

$${W}_{l , m , p , n}^{1 , 2 , 1} = \frac{1}{\sqrt{{P}_{CSI–RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ]$$

$${W}_{l , m , p , n}^{1 , 4 , 1} = \frac{1}{\sqrt{{P}_{CSI–RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ]$$

$$with$$

$$p = \{ \begin{matrix}{p}_{1} & {N}_{g} = 2 \\ [ \begin{matrix}{p}_{1} & {p}_{2} & {p}_{3}\end{matrix} ] & {N}_{g} = 4\end{matrix} ,$$

and the following rank 1 (1-layer) pre-coder structure for codebookMode=2:

$${W}_{l , m , p , n}^{( 1 )} = {W}_{l , m , p , n}^{1 , {N}_{g} , 2}$$

$$where$$

$${W}_{l , m , p , n}^{1 , 2 , 2} = \frac{1}{\sqrt{{P}_{CSI–RS}}} [ \begin{matrix}{v}_{l , m} \\ {φ}_{{n}_{0}} {v}_{l , m} \\ {a}_{{p}_{1}} {b}_{{n}_{1}} {v}_{l , m} \\ {a}_{{p}_{2}} {b}_{{n}_{2}} {v}_{l , m}\end{matrix} ]$$

$$with$$

$$\begin{matrix}p = [ \begin{matrix}{p}_{1} & {p}_{2}\end{matrix} ] \\ n = [ \begin{matrix}{n}_{0} & {n}_{1} & {n}_{2}\end{matrix} ]\end{matrix} ,$$

where P_{CSI-RS}=2N_{g}N₁N₂ is a number of CSI-RS antenna ports. For codebookMode=1, the supported values for each of n, p₁, p₂, p₃ is {0,1,2,3}, which corresponds to QPSK co-phase {1, j, −1, −j}. For codebookMode=2, the supported values of n₀ is {0,1,2,3} which indicates QPSK co-phase {1, j, −1, −j}, the supported values for each of p₁, p₂ is {0,1,2,3}, which indicates co-phase

$$\{ {e}^{j \frac{π}{4}} , {e}^{j \frac{3 π}{4}} , {e}^{j \frac{5 π}{4}} , {e}^{j \frac{7 π}{4}} \} ,$$

and the supported values for each of n₁, n₂ is {0,1}, which indicates co-phase

$$\{ {e}^{- j \frac{π}{4}} , {e}^{j \frac{π}{4}} \} .$$

### That is,

aₚ=e^{jπ/4}e^{jπp/2}

bₙ=e^{jπ/4}e^{nπp/2}

The supported values of (N_{g}, N₁, N₂, O₁, O₂) is given by Table 2.

TABLE 2
Supported configurations of (N_{g}, N₁, N₂) and (O₁, O₂)

| Number of CSI-RS | | |
|---|---|---|
| antenna ports, _{P}_{_{CSI-RS}} | (N_{g}, N₁, N₂) | (O₁, O₂) |
| 8 | (2, 2, 1) | (4, 1) |
| 16 | (2, 4, 1) | (4, 1) |
| | (4, 2, 1) | (4, 1) |
| | (2, 2, 2) | (4, 4) |
| 32 | (2, 8, 1) | (4, 1) |
| | (4, 4, 1) | (4, 1) |
| | (2, 4, 2) | (4, 4) |
| | (4, 2, 2) | (4, 4) |

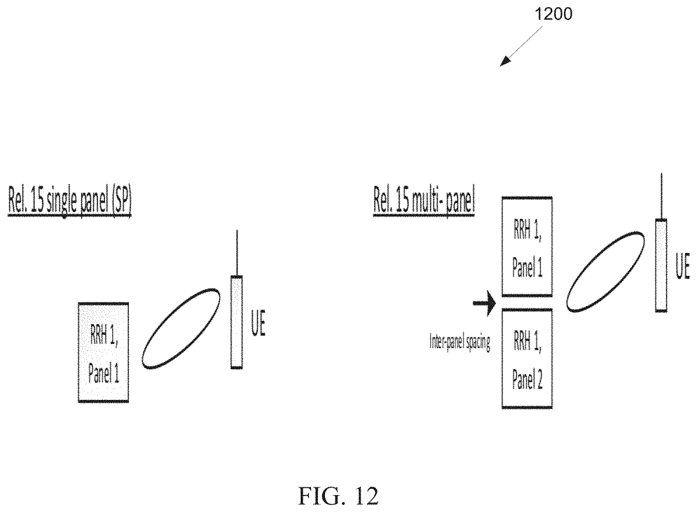

An illustration of Rel. 15 Type I single panel (SP) and Type I multi-panel (MP) codebook based MIMO transmission is shown in FIG. 12. It will be understood by those skilled in the art that FIG. 12 illustrates an example Type I single panel (SP) and Type I multi-panel (MP) codebook based MIMO transmission 1200 according to embodiments of the present disclosure. The embodiment of the Type I single panel (SP) and Type I multi-panel (MP) codebook based MIMO transmission 1200 illustrated in FIG. 12 is for illustration only. FIG. 12 does not limit the scope of this disclosure to any particular implementation of the Type I single panel (SP) and Type I multi-panel (MP) codebook based MIMO transmission 1200.

In this disclosure, several codebook design alternatives for D-MIMO antenna structure are proposed.

In one example, the antenna architecture of a D-MIMO system is structured. For example, the antenna structure at each RRH is dual-polarized (single or multi-panel as shown in FIG. 11. The antenna structure at each RRH can be the same. Alternatively, the antenna structure at an RRH can be different from another RRH. Likewise, the number of ports at each RRH can be the same. Alternatively, the number of ports of one RRH can be different from another RRH.

In another example, the antenna architecture of a D-MIMO system is unstructured. For example, the antenna structure at one RRH can be different from another RRH.

We assume a structured antenna architecture in this disclosure.

In one embodiment I.1, a UE is configured with a D-MIMO codebook (e.g., via higher layer signaling), wherein a value for the number of RRHs is parameterized by N_{RRH}.

In one example I.1.1, a value of N_{RRH} is fixed. For example, N_{RRH}=2 or 3 or 4 or 8.

In one example 1.1.2, a value of N_{RRH} is configured, e.g., as part of the codebook configuration or CSI reporting configuration via RRC signaling, or indicated via MAC CE or DCI or a combination of two or more of RRC, MAC CE and DCI. The value of N_{RRH} is configured from a set of supported values. In one example, the set of supported values is {2,4} or {2,3,4} or {2,4,8} or {2,4,6,8}.

In one example, a separate RRC parameter is used to configure a value for N_{RRH}.

In one example, a joint RRC parameter is used to configure a value for N_{RRH} and a value for at least one additional parameter. For example, the parameter N₉ in Rel. 15 Type I multi-panel codebook can be used as a joint parameter for both N₉ and N_{RRH}.

In one example 1.1.3, a value of N_{RRH} (whether fixed or configured) is subject to a constraint (or condition). In one example of the constraint, the total number of ports across all RRHs belongs to a set of values {4,8,12,16,24,32} or {4,8,12,16,24,32,48,64} or {8,16,24,32} or {8,16,24,32,48,64}.

In one embodiment I.2, the total number of ports across all RRHs, denoted as N_{CSI-RS}, is determined according to at least one of the following examples.

In one example I. 2.1, N_{CSI-RS}=N_{RRH}×N_{CSI-RS,r}=2N_{RRH}N₁N₂ wherein it is assumed that the antenna structure is the same at each RRH, i.e., N_{CSI-RS,r}=2N₁N₂ for all r=1, . . . , N_{RRH}. In one example, N_{CSI-RS}=Σᵣ₌₁^{N}^{_{RRH}}N_{CSI-RS,r}=Σᵣ₌₁^{N}^{_{RRH}}2N_{1,r}N_{2,r} where (N_{1,r}, N_{2,r}) is a parameter for r-th RRH, assuming that the antenna structure can be different across RRHs, i.e., N_{CSI-RS,r}=2N_{1,r}N_{2,r}.

The parameter (N₁, N₂) can be configured via RRC, e.g., based on Table 1 for Rel. 15 Type I single panel (or multi-panel) codebook. Likewise, the parameters (N_{1,r}, N_{2,r}) for each r can be configured via RRC, e.g., based on Table 1 for Rel. 15 Type I single panel (or multi-panel) codebook. In one example, (N_{RRH}, N₁, N₂) is configured (via RRC) similar to Rel. 15 Type I multi-panel codebook, Table 2, by mapping them to (N_{g}, N₁, N₂). In one example, when N_{CSI-RS,r}=2, the value (N₁, N₂) or (N_{1,r}, N_{2,r})=(1,1).

In one example I.2.1A, N_{CSI-RS}=N_{RRH}×N_{CSI-RS,r} wherein it is assumed that the antenna structure is the same at each RRH, i.e., N_{CSI-RS,r}=P for all r=1. . . , N_{RRH}. In one example, N_{CSI-RS}=Σᵣ₌₁^{N}^{_{RRH}}N_{CSI-RS,r} where N_{CSI-RS,r} is a parameter for r-th RRH, assuming that the antenna structure can be different across RRHs. The parameter P can be configured via RRC, e.g., from {2,4,8,12,16,24,32} or {4,8,12,16,24,32}. Likewise, the parameter N_{CSI-RS,r} for each r can be configured via RRC, e.g., from {2,4,8,12,16,24,32} or {4,8,12,16,24,32}.

In one example, N_{RRH} and N_{CSI-RS,r} values are such that N_{CSI-RS}=N_{RRH}×N_{CSI-RS,r} belongs to {4,8,12,16,24,32} or {4,8,12,16,24,32,48} or {4,8,12,16,24,32,48,64} or {8,12,16,24,32} or {8,12,16,24,32,48} or {8,12,16,24,32,48,64}.
In one example, when N_{RRH}=2, N_{CSI-RS,r} belongs to {2,4,8,12,16} or {2,4,8,12,16,24} or {2,4,8,12,16,24,32} or {4,8,12,16} or {4,8,12,16,24} or {4,8,12,16,24,32}.
In one example, when N_{RRH}=⁴, N_{CSI-RS,r} belongs to {2,4,8} or {2,4,8,12} or {2,4,8,12,16} or {4,8} or {4,8,12} or {4,8,12,16}.
In one example, when N_{RRH}=8, N_{CSI-RS,r} belongs to {2,4} or {2,4,8} or {4} or {4,8}.

In one example, N_{CSI-RS,r} values for r=1, . . . , N_{RRH} and different values of the total number of CSI-RS ports is according to at least one of the examples in Table 3.

TABLE 3

| | (N_{CSI-RS,1}, N_{CSI-RS,2}) | (N_{CSI-RS,1}, N_{CSI-RS,2}, N_{CSI-RS,3}) | (N_{CSI-RS,1}, N_{CSI-RS,2}, N_{CSI-RS,3}, N_{CSI-RS,4}) |
|---|---|---|---|
| N_{CSI-RS} | for N_{RRH} = 2 | for N_{RRH} = 3 | for N_{RRH} = 4 |
| 4 | (2, 2) | | |
| 8 | (4, 4) | (4, 2, 2), or it's any combinations | (2, 2, 2, 2) |
| 12 | (8, 4) | (4, 4, 4) | (4, 4, 2, 2) or it's any combinations |
| | | (8, 2, 2), or it's any combinations | |
| 16 | (8, 8), | (8, 4, 4), or it's any combinations | (4, 4, 4, 4), or it's any combinations |
| | (12, 4) or (4, 12) | | (8, 4, 2, 2), or it's any combinations |
| 24 | (16, 8) or (8, 16), | (8, 8, 8) | (8, 8, 4, 4), or it's any combinations |
| | (12, 12) | (12, 8, 4), or it's any combinations | (16, 4, 2, 2), or it's any combinations |
| | | (16, 4, 4), or it's any combinations | |
| 32 | (24, 8) or (8, 24), | (12, 12, 8), or it's any combinations | (8, 8, 8, 8) |
| | (16, 16) | (16, 12, 4), or it's any combinations | (12, 12, 4, 4), or it's any combinations |
| | | (16, 8, 8), or it's any combinations | (12, 8, 8, 4), or it's any combinations |
| | | (24, 4, 4), or it's any combinations | (16, 8, 4, 4), or it's any combinations |
| | | | (16, 12, 2, 2), or it's any combinations |
| 48 | (32, 16) or (16, 32), | (16, 16, 16) | (12, 12, 12, 12) |
| | (24, 24) | (24, 16, 8), or it's any combinations | (16, 16, 8, 8), or it's any combinations |
| | | (32, 12, 4), or it's any combinations | (16, 16, 12, 4), or it's any combinations |
| | | (32, 8, 8), or it's any combinations | (24, 16, 4, 4), or it's any combinations |
| | | | (24, 12, 8, 4), or it's any combinations |
| | | | (24, 8, 8, 8), or it's any combinations |
| | | | (32, 8, 4, 4), or it's any combinations |
| | | | (32, 12, 2, 2), or it's any combinations |
| 64 | (32, 32), | (24, 24, 16), or it's any | (16, 16, 16, 16) |
| | (48, 16) or (16, 48) | combinations | (24, 16, 12, 12), or it's any combinations |
| | | (32, 24, 8), or it's any combinations | (24, 16, 16, 8), or it's any combinations |
| | | (32, 16, 16), or it's any | (24, 24, 12, 4), or it's any combinations |
| | | combinations | (24, 24, 8, 8), or it's any combinations |
| | | | (32, 24, 4, 4), or it's any combinations |
| | | | (32, 16, 12, 4), or it's any combinations |
| | | | (32, 16, 8, 8), or it's any combinations |
| | | | (32, 12, 12, 8), or it's any combinations |

In one example, the UE is configured with one CSI-RS resource with N_{CSI-RS} CSI-RS ports that are distributed across all RRHs. In one example, the UE is configured with N_{RRH} CSI-RS resources, where the r-th CSI-RS resource with N_{CSI-RS,r} CSI-RS ports is associated with the r-th RRH.

In one example I.2.2, N_{CSI-RS}=N_{RRH}N₁N₂ wherein it is assumed that the antenna structure is the same at each RRH, i.e., N_{CSI-RS,r}=N₁N₂ for all r=1, . . . N_{RRH}. In one example, N_{CSI-RS}=Σᵣ₌₁^{N}^{_{RRH}}N_{CSI-RS,r}=Σᵣ₌₁^{N}^{_{RRH}}2N_{1,r}N_{2,r} where (N_{1,r}, N_{2,r}) is a parameter for r-th RRH, assuming that the antenna structure can be different across RRHs, i.e., N_{CSI-RS,r}=N_{1,r}N_{2,r}.

In one example I.2.3, N_{CSI-RS}=aN_{RRH}N₁N₂ wherein a=1 (e.g., co-polarized antenna) or 2 (e.g., dual-polarized antenna) and it is assumed that the antenna structure is the same at each RRH, i.e., N_{CSI-RS,r}=N₁N₂ for all r=1, . . . , N_{RRH}. In one example, N_{CSI-RS}=Σᵣ₌₁^{N}^{_{RRH}}N_{CSI-RS,r}=Σᵣ₌₁^{N}^{_{RRH}}2N_{1,r}N_{2,r} where aᵣ=1 or 2 and (N_{1,r}, N_{2,r}) is a parameter for r-th RRH, assuming that the antenna structure can be different across RRHs, i.e., N_{CSI-RS,r}=aᵣN_{1,r}N_{2,r}. The value of aᵣ can be the same across RRHs. Alternatively, it can be different, hence can vary across RRHs.

In one embodiment I.3, the CSI-RS port numbering for D-MIMO is according to at least one of the following examples.

In one example I.3.1, the CSI-RS ports are numbered in the following order: CSI-RS ports for RRH1, CSI-RS ports for RRH2 and so on.

| | RRH1 | RRH2 | . . . | RRH_{N}_{_{RRH}} |
|---|---|---|---|---|
| | 1, . . . , | 1, . . . , | | 1, . . . , N_{CSI-RS,N}_{_{RRH}} |
| | N_{CSI-RS,1} | N_{CSI-RS,2} | | |
| CSI-RS | 1, . . . , | x + 1, . . . , | | x + 1, . . . , x + |
| port | N_{CSI-RS,1} | x + N_{CSI-RS,2} | | N_{CSI-RS,N}_{_{RRH}} |
| number | | where | | where |
| | | x = N_{CSI-RS,1} | | x = Σᵣ₌₁^{N}^{_{RRH}}⁻¹ αᵣN_{1,r}N_{2,r} |
| | | =α₁N_{1,1}N_{2,1} | | |

In one example I.3.2, the CSI-RS ports are numbered in the following order: CSI-RS ports with a first polarization for RRH1, CSI-RS ports with a second polarization for RRH1, CSI-RS ports with a first polarization for RRH2, CSI-RS ports with a second polarization for RRH2, and so on.

| | RRH1 | | RRH2 | | |
|---|---|---|---|---|---|
| | 1^{st} pol | 2^{nd} pol | 1^{st} pol | 2^{nd} pol | . . . |
| | 1, . . . , N_{1,1}N_{2,1} | N_{1,1}N_{2,1} + 1, . . . , 2N_{1,1}N_{2,1} | 1, . . . , N_{1,2}N_{2,2} | N_{1,2}N_{2,2} + 1, . . . , 2N_{1,2}N_{2,2} | |
| CSI-RS | 1, . . . , N_{1,1}N_{2,1} | N_{1,1}N_{2,1} + 1, . . . , 2N_{1,1}N_{2,1} | x + 1, . . . , | y + 1, . . . , y + N_{1,2}N_{2,2} | |
| port | | | x + N_{1,2}N_{2,2} | where y = | |
| number | | | where x = | 2N_{1,1}N_{2,1} + N_{1,2}N_{2,2} | |
| | | | 2N_{1,1}N_{2,1} | | |

In one example I.3.3, the CSI-RS ports are numbered in the following order: CSI-RS ports with a first polarization for RRH1, CSI-RS ports with a first polarization for RRH2, CSI-RS ports with a second polarization for RRH1, CSI-RS ports with a second polarization for RRH2.

In one example, a first polarization refers to one first half (a first group) of the antenna ports with a first antenna polarization (e.g., +45), and a second polarization refers to one second half (a second group) of the antenna ports with a second antenna polarization (e.g., −45).

In one embodiment II.1, a UE is configured with a D-MIMO codebook (e.g., via higher layer signaling) which has a dual-stage pre-coder structure (for each layer), e.g., similar to (or based on) Rel. 15 NR Type II codebooks, or a triple-stage pre-coder structure (for each layer), e.g., similar to (or based on) Rel. 16 NR Type II codebooks. For the two-stage, the pre-coder for a layer can be represented as W=W₁W₂ where the component W₁ is used to report/indicate a basis matrix comprising L basis vectors, and the component W₂ is used to report/indicate one out of L basis vector selection (for each layer), which is common for two polarizations, and a co-phase value for the two polarizations. Note that when L=1, there is no need for any beam selection via W₂. For the three stage, the N₃ pre-coders for a layer can be represented as W=W₁\tilde{W}₂W_{f}^{H} where the component W₁ is used to report/indicate a spatial domain (SD) basis matrix comprising SD basis vectors, the component W_{f} is used to report/indicate a frequency domain (FD) basis matrix comprising FD basis vectors, and the component W₂ is used to report/indicate coefficients corresponding to SD and FD basis vector pairs.

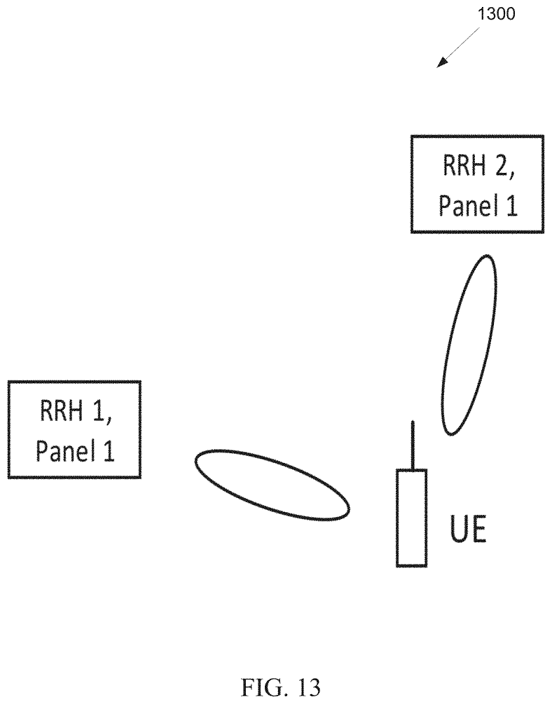

FIG. 13 illustrates an example D-MIMO 1300 where each RRH has a single antenna panel according to embodiments of the present disclosure. The embodiment of the D-MIMO 1300 where each RRH has a single antenna panel illustrated in FIG. 13 is for illustration only. FIG. 13 does not limit the scope of this disclosure to any particular implementation of the D-MIMO 1300 where each RRH has a single antenna panel.

As illustrated in FIG. 13, in one embodiment 11.2, each RRH has a single antenna panel. The component W₁ has a block diagonal structure comprising X diagonal blocks, where 1 (co-pol) or 2 (dual-pol) diagonal blocks are associated with each RRH.

In one example II.2.1, X=N_{RRH} assuming co-polarized (single polarized) antenna structure at each RRH. In one example, when N_{RRH}=2, the components W₁ is given by

$${W}_{1} = [ \begin{matrix}{B}_{1} & 0 \\ 0 & {B}_{2}\end{matrix} ]$$

where B₁ is a basis matrix for the 1^{st} RRH, and B₂ is a basis matrix for the 2^{nd} RRH. In one example, Bᵣ=[b_{r,0}, b_{r,1}, . . . , b_{r,L}₋₁] comprises Lᵣ columns or beams (or basis vectors) for r-th RRH. In one example, Lᵣ=L for all r values (RRH-common L value), for example, L=1. In one example, Lᵣ can be different across RRHs (RRH-specific L value), for example, Lᵣ can take a value (fixed or configured) from {1,4}.

In one example II.2.2, X=2N_{RRH} assuming dual-polarized (cross-polarized) antenna structure at each RRH.

In one example, when N_{RRH}=2, the components W₁ is given by

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} RRH and is common (the same) for the two polarizations, which correspond to the first and second diagonal blocks, and B₂ is a basis matrix for the 2^{nd} RRH and is common (the same) for the two polarizations, which correspond to the third and fourth diagonal blocks. In general, (2r−1) -th and (2r) -th diagonal blocks correspond to the two antenna polarizations for the r-th RRH. In one example, Bᵣ=[b_{r,0}, b_{r,1}, . . . , b_{r,L}_{ᵣ}₋₁] comprises Lᵣ columns or beams (or basis vectors) for r-th RRH. In one example, Lᵣ=L for all r values (RRH-common L value), for example, L=1. In one example, Lᵣ can be different across RRHs (RRH-specific L value), for example, Lᵣ can take a value (fixed or configured) from {1,4}.

In one example, when N_{RRH}=2, the components W₁ is given by

$${W}_{1} = [ \begin{matrix}{B}_{1} & 0 & 0 & 0 \\ 0 & {B}_{2} & 0 & 0 \\ 0 & 0 & {B}_{1} & 0 \\ 0 & 0 & 0 & {B}_{2}\end{matrix} ]$$

where B₁ is a basis matrix for the 1^{st} RRH and is common (the same) for the two polarizations, which correspond to the first and third diagonal blocks, and B₂ is a basis matrix for the 2^{nd} RRH and is common (the same) for the two polarizations, which correspond to the second and fourth diagonal blocks. In general, r-th and (r+N_{RRH})-th diagonal blocks correspond to the two antenna polarizations for the r -th RRH. In one example, Bᵣ=[b_{r,0}, b_{r,1}, . . . , b_{r,Lr-1}] comprises Lᵣ columns or beams (or basis vectors) for r-th RRH. In one example, Lᵣ=L for all r values (RRH-common L value), for example, L=1. In one example, Lᵣ can be different across RRHs (RRH-specific L value), for example, Lᵣ can take a value (fixed or configured) from {1,4}.

In one example, when N_{RRH}=2, the components W₁ is given by

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} RRH, which correspond to the first and second diagonal blocks, and B_{2,1} and B_{2,2} are basis matrices for the first and second antenna polarizations of the 2^{nd} RRH, which correspond to the third and fourth diagonal blocks. In general, (2r−1) -th and (2r)-th diagonal blocks correspond to the two antenna polarizations for the r -th RRH. In one example, B_{r,p}=[b_{r,p}, b_{r,p,1}, . . . , b_{r,p,L}_{_{r,p}}₋₁] comprises L_{r,p} columns or beams (or basis vectors) for p-th polarization of r-th RRH. In one example, L_{r,p}=L for all r and p values (RRH-common and polarization-common L value), for example L=1. In one example, L_{r,p}=Lᵣ for all p values (RRH-specific and polarization-common L value). In one example, L_{r,p}=Lₚ for all r values (RRH-common and polarization-specific L value). In one example, L_{r,p} can be different across RRHs (RRH-specific and polarization-specific L value).

In one example, when N_{RRH}=2, the components W₁ is given by

$${W}_{1} = [ \begin{matrix}{B}_{1 , 1} & 0 & 0 & 0 \\ 0 & {B}_{2 , 1} & 0 & 0 \\ 0 & 0 & {B}_{1 , 2} & 0 \\ 0 & 0 & 0 & {B}_{2 , 2}\end{matrix} ]$$

where B_{1,1} and B_{1,2} are basis matrices for the first and second antenna polarizations of the 1^{st} RRH which correspond to the first and third diagonal blocks, and B_{2,1} and B_{2,2} are basis matrices for the first and second antenna polarizations of the 2^{nd} RRH, which correspond to the second and fourth diagonal blocks. In general, r-th and (r+N_{RRH})-th diagonal blocks correspond to the two antenna polarizations for the r-th RRH. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th RRH. In one example, L_{r,p}=L for all r and p values (RRH-common and polarization-common L value), for example L=1. In one example, L_{r,p}=Lᵣ for all p values (RRH-specific and polarization-common L value). In one example, L_{r,p}=Lₚ for all r values (RRH-common and polarization-specific L value). In one example, L_{r,p} can be different across RRHs (RRH-specific and polarization-specific L value).

In one example II.2.3, X=Σᵣ₌₁^{N}^{_{RRH}} aᵣ, where aᵣ=1 for co-polarized (single polarized) antenna structure at r-th RRH, and aᵣ=2 for dual-polarized (cross-polarized) antenna structure at r-th RRH.

In one example, when N_{RRH}=2, the components W₁ is given by

$${W}_{1} = [ \begin{matrix}{B}_{1} & 0 & 0 \\ 0 & {B}_{2} & 0 \\ 0 & 0 & {B}_{2}\end{matrix} ]$$

where B₁ is a basis matrix for the 1^{st} RRH, and B₂ is a basis matrix for the 2^{nd} RRH and is common (the same) for the two polarizations, which correspond to the second and third diagonal blocks.

In one example, when N_{RRH}=2, the components W₁ is given by

$${W}_{1} = [ \begin{matrix}{B}_{1} & 0 & 0 \\ 0 & {B}_{2 , 1} & 0 \\ 0 & 0 & {B}_{2 , 2}\end{matrix} ]$$

where B₁ is a basis matrix for the 1^{st} RRH, and B_{2,1} and B_{2,2} are basis matrices for the first and second antenna polarizations of the 2^{nd} RRH, which correspond to the second and third diagonal blocks.

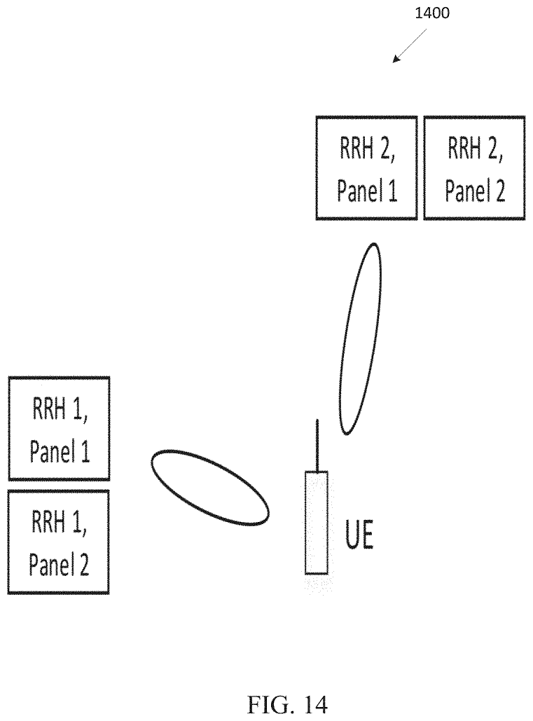

FIG. 14 illustrates an example D-MIMO 1400 where each RRH has multiple antenna panels according to embodiments of the present disclosure. The embodiment of the D-MIMO 1400 where each RRH has multiple antenna panels illustrated in FIG. 14 is for illustration only. FIG. 14 does not limit the scope of this disclosure to any particular implementation of the D-MIMO 1400 where each RRH has multiple antenna panels.

As illustrated in FIG. 14, in one embodiment II.3, each RRH has multiple antenna panels. The component W₁ has a block diagonal structure comprising X diagonal blocks, where N_{g,r} (co-pol) or 2N_{g,r} (dual-pol) diagonal blocks are associated with r-th RRH comprising N_{g,r} panels and N_{g,r}22 1 for all values of r. Note N_{g,r}=2 for both RRHs in FIG. 14.

The examples in embodiment II.2 can be extended in a straightforward manner in this case (of multiple panels at RRHs) by adding the diagonal blocks corresponding to multiple panels in W₁.

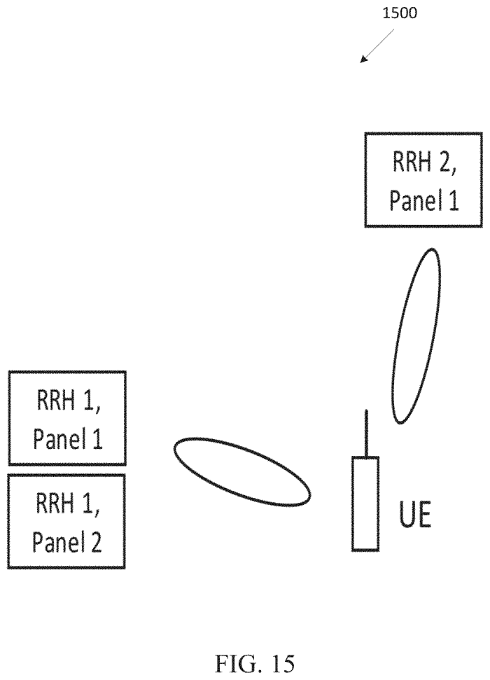

FIG. 15 illustrates an example D-MIMO 1500 where each RRH can have a single antenna panel or multiple antenna panels according to embodiments of the present disclosure. The embodiment of the D-MIMO 1500 where each RRH can have a single antenna panel or multiple antenna panels illustrated in FIG. 15 is for illustration only. FIG. 15 does not limit the scope of this disclosure to any particular implementation of the D-MIMO 1500 where each RRH can have a single antenna panel or multiple antenna panels.

As illustrated in FIG. 15, in one embodiment II.4, each RRH can have a single antenna panel or multiple antenna panels. The component W₁ has a block diagonal structure comprising X diagonal blocks, where N_{g,r} (co-pol) or 2N_{g,r} (dual-pol) diagonal blocks are associated with r-th RRH comprising N_{g,r} panels, and N_{g,r}=1 when r-th RRH has a single panel and N_{g,r}>1 when r-th RRH has multiple panels.

The examples in embodiment II.2 can be extended in a straightforward manner in this case (of multiple panels at RRHs) by adding the diagonal blocks corresponding to multiple panels in W₁.

In one embodiment II.5, the basis matrices comprising the diagonal blocks of the component W₁ have columns that are selected from a set of oversampled 2D DFT vectors. When the antenna port layout is the same across RRHs, for a given antenna port layout (N₁, N₂) and oversampling factors (O₁, O₂) for two dimensions, a DFT vector v_{l,m} can be expressed as follows.

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0,1, . . . , O₁N₁−1} and m∈{0,1, . . . , O₂N₂−1}.

When the antenna port layout can be different across RRHs, for a given antenna port layout (N_{1,r}, N_{2,r}) and oversampling factors (O_{1,r}, O_{2,r}) associated with r-th RRH, a DFT vector can be expressed as follows.

$${v}_{{l}_{r} , {m}_{r}} = {[ \begin{matrix}{u}_{{m}_{r}} & {e}^{j \frac{2 π {l}_{r}}{{O}_{1 , r} {N}_{1 , r}}} {u}_{{m}_{r}} & … & {e}^{j \frac{2 π {l}_{r} ( {N}_{1 , r} - 1 )}{{O}_{1 , r} {N}_{1 , r}}} {u}_{{m}_{r}}\end{matrix} ]}^{T}$$

$${u}_{{m}_{r}} = [ \begin{matrix}1 & {e}^{j \frac{2 π {m}_{r}}{{O}_{2 , r} {N}_{2 , r}}} & … & {e}^{j \frac{2 π {m}_{r} ( {N}_{2 , r} - 1 )}{{O}_{2 , r} {N}_{2 , r}}}\end{matrix} ]$$

where lᵣ∈{0,1, . . . , O_{1,r}N_{1,r}−1} and m∈{0,1, . . . , O_{2,r}N_{2,r}−1}.

In one example, the oversampling factor is RRH-common, hence remains the same across RRHs. For example, e.g., O_{1,r}=O₁=O_{2,r}=O ₂32 4. In one example, the oversampling factor is RRH-specific, hence is independent for each RRH. For example, O_{1,r}=O_{2,r}=x and x is chosen (fixed or configured) from {2,4,8}.

In one example, the oversampling factor is fixed, e.g., O₁=O₂=4 for low-resolution (Type I) codebook and O₁=O₂=1 for high-resolution (Type II) codebook. In one example, the oversampling factor is configured, e.g., via RRC, where the configured value(s) is common for all RRHs, or independent for each RRH (i.e., one value is configured for each RRH).

In one embodiment II.6, each RRH can have a single antenna panel or multiple antenna panels (cf. FIG. 15). The component W₁ has a block diagonal structure comprising X=2 diagonal blocks, where N_{g,r} (co-pol) or 2N_{g,r} (dual-pol) diagonal blocks are associated with r-th RRH comprising N_{g,r} panels, and N_{g,r}=1 when r-th RRH has a single panel and N_{g,r}>1 when r-th RRH has multiple panels.

In one embodiment III.1, the codebook includes additional components due to N_{RRH}>1 RRHs.

In one example III.1.1, the additional components include inter-RRH phase. In one example, the inter-RRH phase values correspond to N_{RRH}−1 phase values (e.g., assuming one of the RRHs is a reference and has a fixed phase value=1). In another example, the inter-RRH phase values correspond to N_{RRH} phase values. The inter-RRH phase values can be quantized/reported as scalars using a scalar codebook (e.g., QPSK, 2 bits per phase or 8PSK, 3 bits per phase) or as a vector using a vector codebook (e.g., a DFT codebook). Also, for a dual-polarized antenna at an RRH, the inter-RRH phase can be the same for two polarizations of the RRH. Alternatively, it can be independent for two polarizations for the RRH. At least one of the following example is used for the inter-RRH phase reporting.
In one example III.1.1.1, the inter-RRH phase is reported in a wideband (WB) manner, i.e., one value is reported for all SBs in the configured CSI reporting band. Due to WB reporting, it can be included in the W₁ component of the codebook. Alternatively, it can be included in a new component, say W₃ of the codebook.
In one example III.1.1.2, the inter-RRH phase is reported in a subband (SB) manner, i.e., one value is reported for each SB in the configured CSI reporting band. Due to SB reporting, it can be included in the W₂ component of the codebook. Alternatively, it can be included in a new component, say W₃ of the codebook.
In one example III.1.1.3, the inter-RRH phase is reported in a WB plus SB manner, i.e., one WB phase value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, say W₃ of the codebook.

In one example III.1.2, the additional components include inter-RRH phase and inter-RRH amplitude, wherein the details about the inter-RRH phase are as explained in example III.1.1. Note that inter-RRH amplitude is needed due to unequal distance of the UE from RRHs. In one example, the inter-RRH amplitude values correspond to N_{RRH}−1 amplitude values (e.g., assuming one of the RRHs is a reference and has a fixed amplitude value=1). In another example, the inter-RRH amplitude values correspond to N_{RRH} amplitude values. The inter-RRH amplitude values can be quantized/reported as scalars using a scalar codebook (e.g., 2 bits per amplitude or 3 bits per amplitude) or as a vector using a vector codebook. Also, for a dual-polarized antenna at an RRH, the inter-RRH amplitude can be the same for two polarizations of the RRH. Alternatively, it can be independent for two polarizations for the RRH. At least one of the following example is used for the inter-RRH amplitude and phase reporting.
In one example III.1.2.1, the inter-RRH amplitude is reported in a wideband (WB) manner, i.e., one value is reported for all SBs in the configured CSI reporting band. Due to WB reporting, it can be included in the W₁ component of the codebook. Alternatively, it can be included in a new component, say W₃ of the codebook. At least one of the following example is used for the inter-RRH phase.
   In one example III.1.2.1.1, the inter-RRH phase is reported is reported according to example III.1.1.1.
   In one example III.1.2.1.2, the inter-RRH phase is reported is reported according to example III.1.1.2.
   In one example III.1.2.1.3, the inter-RRH phase is reported is reported according to example III.1.1.3.
In one example III.1.2.2, the inter-RRH amplitude is reported in a subband (SB) manner, i.e., one value is reported for each SB in the configured CSI reporting band. Due to SB reporting, it can be included in the W₂ component of the codebook. Alternatively, it can be included in a new component, say W₃ of the codebook. At least one of the following example is used for the inter-RRH phase.
   In one example III.1.2.2.1, the inter-RRH phase is reported is reported according to example III.1.1.1.
   In one example III.1.2.2.2, the inter-RRH phase is reported is reported according to example III.1.1.2.
   In one example III.1.2.2.3, the inter-RRH phase is reported is reported according to example III.1.1.3.
In one example III.1.2.3, the inter-RRH amplitude is reported in a WB plus SB manner, i.e., one WB amplitude value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, say W₃ of the codebook. At least one of the following example is used for the inter-RRH phase.
   In one example III.1.2.3.1, the inter-RRH phase is reported is reported according to example III.1.1.1.
   In one example I11.1.2.3.2, the inter-RRH phase is reported is reported according to example III.1.1.2.
   In one example I11.1.2.3.3, the inter-RRH phase is reported is reported according to example III.1.1.3.

In one example III.1.3, the additional components include inter-RRH amplitude, wherein the details about the inter-RRH amplitude are as explained in example I11.1.2.

In one example III.1.4, the additional components include inter-RRH power, wherein the details about the inter-RRH power are as explained in example III.1.2 by replacing amplitude with power. In one example, a square of inter-RRH amplitude equals inter-RRH power.

In one example III.1.5, the additional components include inter-RRH phase and inter-RRH power, wherein the details about the inter-RRH phase are as explained in example III.1.1, and the details about the inter-RRH power are as explained in example III.1.2 by replacing amplitude with power. In one example, a square of inter-RRH amplitude equals inter-RRH power.

In one example III.1.6, the additional components include an indicator indicating the strongest RRH (for reference). Due to distributed architecture, the strongest RRH can be reported in order to indicate the reference RRH with respect to which the inter-RRH components (such as amplitude or/and phase) are reported. The inter-RRH amplitude and phase associated with the strongest RRH can be set to a fixed value, for example 1. At least one of the following example is used for the strongest RRH reporting.
In one example III.1.6.1, the strongest RRH (indicator) is reported in a WB manner, i.e., one value (indicator) is reported for all SBs. Due to WB reporting, it can be included in the W₁ component of the codebook. Alternatively, it can be included in a new component, say W₃ of the codebook.
In one example III.1.6.2, the strongest RRH (indicator) is reported in a SB manner, i.e., one value (indicator) is reported for each SB. Due to SB reporting, it can be included in the W₂ component of the codebook. Alternatively, it can be included in a new component, say W₃ of the codebook.

In one example, the strongest RRH is reported in a layer-common manner, i.e., one strongest RRH is reported common for all layers when number of layers >1 (or rank >1).

In one example, the strongest RRH is reported in a layer-specific manner, i.e., one strongest RRH is reported for each layer of the number of layers when number of layers >1 (or rank >1).

The amplitude/phase associated with the strongest RRH can be fixed, e.g., to 1. In an alternate design, the strongest RRH can be configured (e.g., via RRC signaling, or indicated via MAC CE or DCI or a combination of two or more of RRC, MAC CE and DCI), or can be fixed (e.g., RRH 1 is always strongest)

In one embodiment III.1.4, an RRH selection is performed wherein a subset of Z RRHs are selected from the N_{RRH} RRHs and the CSI is reported for the selected Z RRHs. In one example, the RRH selection is configured via RRC signaling, or indicated via MAC CE or DCI or a combination of two or more of RRC, MAC CE and DCI. In another example, the RRH selection is performed by the UE, for example, the UE reports an indicator for this selection or reports inter-RRH amplitude (or power)=0 indicating that an RRH is not selected.

In one example, the RRH selection is performed in a layer-common manner, i.e., the RRH selection is performed common for all layers when number of layers >1 (or rank >1).

In one example, the RRH selection is performed in a layer-specific manner, i.e., the RRH selection is performed for each layer of the number of layers when number of layers >1 (or rank >1).

In one example III.1.4.1, the UE is configured with a Type I codebook for D-MIMO (e.g., by setting RRC parameter codebookType=Typel-D-MIMO), wherein the codebook includes a component for RRH selection (ON/OFF). In one example, this component is separate (dedicated for RRH selection). For example, a bit sequence comprising N_{RRH} bits is used where each bit of the bit sequence is associated with an RRH, and the bit value ‘1’ is used to indicate that the RRH is selected and the bit value ‘0’ is used to indicate that the RRH is not selected. For example, a combinatorial index, indicated via

$$⌈ {log}_{2} ( \begin{matrix}{N}_{R R H} \\ Z\end{matrix} ) ⌉ bits$$

signaling, is used to indicate

$$( \begin{matrix}{N}_{R R H} \\ Z\end{matrix} )$$

selection hypotheses, W1 basis vector selection in Rel. 15 NR Type I codebook.

In another example, this component is combined (joint) with an amplitude component of the codebook, where the amplitude codebook includes a value 0 (in addition to other values greater than 0), and the value ‘0’ is used to indicate/report that the RRH is not selected and the bit value greater than 0 is used to indicate/report that the RRH is selected and the indicated/reported value indicates the amplitude weighting in the precoder equation/calculation.

In one example III.1.4.2, the UE is configured with a Type II codebook (or Type II port selection) for D-MIMO (e.g., by setting RRC parameter codebookType=TypeII-D-MIMO or TypeII-PortSelection-D-MIMO), wherein the codebook includes a component for RRH selection (ON/OFF).

In one example, this component is separate (dedicated for RRH selection). For example, a bit sequence comprising N_{RRH} bits is used where each bit of the bit sequence is associated with an RRH, and the bit value 1′ is used to indicate that the RRH is selected and the bit value ‘0’ is used to indicate that the RRH is not selected. For example, a combinatorial index, indicated via

$$⌈ {log}_{2} ( \begin{matrix}{N}_{R R H} \\ Z\end{matrix} ) ⌉ bits$$

signaling, is used to indicate

$$( \begin{matrix}{N}_{R R H} \\ Z\end{matrix} )$$

RRH selection hypotheses, W1 basis vector selection in Rel. 15 NR Type I codebook.

In another example, this component is combined (joint) with an amplitude component of the codebook, where the amplitude codebook includes a value 0 (in addition to other values greater than 0), and the value ‘0’ is used to indicate/report that the RRH is not selected and the bit value greater than 0 is used to indicate/report that the RRH is selected and the indicated/reported value indicates the amplitude weighting in the precoder equation/calculation.

In one example III.1.4.3, a UE is configured to report the CSI based on the D-MIMO codebook using a two-part UCI, UCI part 1 and UCI part 2, and the UCI part 1 is used indicate/report the RRH selection. In one example, the two-part UCI is configured only when the UE is configured to report the SB CSI reporting based on the D-MIMO codebook. In one example, the two-part UCI is configured only when the UE is configured with the Type II or Type II port selection codebook for D-MIMO.

In one example III.1.4.4, a UE is configured to report the CSI based on the D-MIMO codebook using a two-part UCI, UCI part 1 and UCI part 2, and the UCI part 2 is used indicate/report the RRH selection. In one example, the two-part UCI is configured only when the UE is configured to report the SB CSI reporting based on the D-MIMO codebook. In one example, the two-part UCI is configured only when the UE is configured with the Type II or Type II port selection codebook for D-MIMO.

In one example III.1.4.5, a UE is configured to report the CSI based on the D-MIMO codebook using one-part UCI, which is used indicate/report the RRH selection. In one example, the one-part UCI is configured only when the UE is configured to report the WB CSI reporting based on the D-MIMO codebook. In one example, the one-part UCI is configured only when the UE is configured with the Type I codebook for D-MIMO.

In one example, a UE is configured with a two-part UCI (part 1 and part 2) for CSI reporting based on D-MIMO codebook.
In one example, UCI part 1 includes the information about the RRH selection.
In one example, UCI part 1 includes the information the strongest RRH.
In one example, UCI part 1 includes both the information the strongest RRH and the information about the RRH selection.
In one example, UCI part 2 includes the information about the RRH selection.
In one example, UCI part 2 includes the information the strongest RRH.
In one example, UCI part 2 includes both the information the strongest RRH and the information about the RRH selection.

In one example, a UE is configured with a one-part UCI for RRH selection reporting.
In one example, this configuration is restricted to the case when WB CSI reporting is configured (i.e., for SB CSI reporting, two-part UCI is used to report RRH selection).
In one example, this configuration is restricted to the case when Type I codebook for D-MIMO is configured (i.e., for Type II codebook, two-part UCI is used to report RRH selection).

In one example, a UE is configured with a one-part UCI for the strongest RRH reporting.
In one example, this configuration is restricted to the case when WB CSI reporting is configured (i.e., for SB CSI reporting, two-part UCI is used to report RRH selection). In one example, this configuration is restricted to the case when Type I codebook for D-MIMO is configured (i.e., for Type II codebook, two-part UCI is used to report RRH selection).

In one example, a UE is configured with a one-part UCI for both RRH selection and the strongest RRH reporting.
In one example, this configuration is restricted to the case when WB CSI reporting is configured (i.e., for SB CSI reporting, two-part UCI is used to report RRH selection). In one example, this configuration is restricted to the case when Type I codebook for D-MIMO is configured (i.e., for Type II codebook, two-part UCI is used to report RRH selection).

In one example, the parameter Z is fixed, e.g., 2. In one example, the parameter Z is configured, e.g., via RRC. In one example, the parameter Z is reported by the UE, e.g., via UCI part 1 of two-part UCI comprising part 1 and part 2. The reported Z value can be based on a minimum value Zₘᵢₙ, i.e., the UE can report any Z such that Zₘᵢₙ≤Z≤N_{RRH}. Alternatively, the reported Z value can be based on a maximum value Zₘₐₓ, i.e., the UE can report any Z such that Z≤Zₘₐₓ. Alternatively, the reported Z value can be based on a minimum value Zₘᵢₙ and a maximum value Zₘₐₓ, i.e., the UE can report any Z such that Zₘᵢₙ≤Z≤Zₘₐₓ. The value Zₘᵢₙ or/and Zₘₐₓ can be fixed, or configured (e.g., RRC) or reported by the UE as part of UE capability reporting.
In one example, both Z and indicator indicating selected RRHs are reported via UCI part 1.
In one example, Z is reported via UCI part 1, and indicator indicating selected RRHs is reported via UCI part 2.

In this disclosure, the codebook component W₁ refers to pre-coder (or pre-coding matrix) components that are indicated via the components of the first PMI indicator i₁. Likewise, the codebook component W₂ refers to pre-coder (or pre-coding matrix) components that are indicated via the components of the second PMI indicator i₂. Likewise, the new codebook component W₃ refers to pre-coder (or pre-coding matrix) components that are indicated via the components of the third PMI indicator i_{3.}

In one embodiment IV.1, the codebook for D-MIMO transmission has one of the fowling designs.

In one example IV.1.1, the codebook has a decoupled (separate) design for inter-RRH and intra-RRH components. For example, (Inter-RRH, Intra-RRH)=(Type I, Type I) or (Type II, Type I) or (Type I, Type II), or (Type II, Type II), wherein the Type I implies that the corresponding codebook components has similarity with Rel. 15 NR Type I codebook, and likewise, Type II implies that the corresponding codebook components has similarity with Rel. 15 or 16 NR Type II codebook.

In one example IV.1.2, the codebook has a coupled (joint) design for inter-RRH and intra-RRH components. For example, (Inter-RRH, Intra-RRH) has a Type I or Type II like design.

In one embodiment IV.2, the W₂ components have one of the following high-level design.

In one example IV.2.1, the W₂ components have Type I structure. In one example, only L=1 or Lᵣ=1 is used in W₁, i.e., only one beam or basis vector is used for each layer (or precoder for each layer). In one example, L>1 or L_{r>}1 (e.g., 4) is used in W₁, i.e., multiple beams or basis vectors are included in W₁, but the UE selects one beam or basis vector out of L beams for each layer (or precoder for each layer). In one example, the UE is configured with either L=1 or L>1 in W₁, and the UE selects/reports W₁ accordingly.
Design 1:
   Single panel: cross-pol co-phase, inter-RRH phase
   Multi-panel: cross-pol co-phase, inter-panel phase, inter-RRH phase
Design 2:
   Single panel: a joint co-phase
   Multi-panel: at least two or all of cross-pol co-phase, inter-panel phase, inter-RRH phase are joint

In one example IV.2.2, the W₂ components has Type II structure. In one example, L>1, and the value of L is configured (e.g., via RRC signaling) from a set of supported values. In one example, the set of supported values belongs to {2,3,4,6}.
Design 1:
   separate amplitude components for polarizations or/and panels or/and RRHs
Design 2:
   joint amplitude

In one embodiment IV.3, the D-MIMO codebook includes both coherent and non-coherent pre-coders, wherein a coherent pre-coder corresponds to a precoder or pre-coding matrix whose all entries all non-zero, and a non-coherent pre-coder corresponds to a precoder or pre-coding matrix who's each row or each column has at least one zero entry.

Any of the above variation embodiments can be utilized independently or in combination with at least one other variation embodiment.

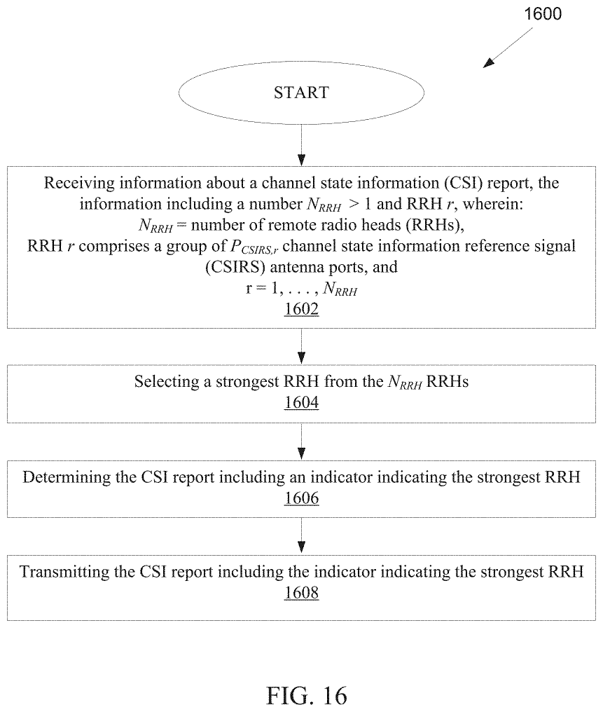

FIG. 16 illustrates a flow chart of a method 1600 for operating a user equipment (UE), as may be performed by a UE such as UE 116, according to embodiments of the present disclosure. The embodiment of the method 1600 illustrated in FIG. 16 is for illustration only. FIG. 18 does not limit the scope of this disclosure to any particular implementation.

As illustrated in FIG. 16, the method 1600 begins at step 1602. In step 1602, the UE (e.g., 111-116 as illustrated in FIG. 1) receives information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (C SIRS) antenna ports, and r=1, . . . , N_{RRH.}

In step 1604, the UE selects a strongest RRH from the N_{RRH} RRHs.

In step 1606, the UE determines the CSI report including an indicator indicating the strongest RRH.

In step 1608, the UE transmits the CSI report including the indicator indicating the strongest RRH.

In one embodiment, for each RRH r=1, . . . , N_{RRH}, the information includes an information about P_{CSIRS,r}.

In one embodiment, P_{CSIRS,r}=2N_{1,r}N_{2,r} and the information about P corresponds to a value of (N_{1,r}, N_{2,r}).

In one embodiment, the strongest RRH is reported as either wideband (WB) or subband (SB), where WB corresponds to a single value that is common for all subbands in a CSI reporting band and SB corresponds to multiple values, one value for each subband in the CSI reporting band.

In one embodiment, the strongest RRH is reported as either layer-common or layer-specific, where the layer-common corresponds to a single value that is common for all layers and the layer-specific corresponds to multiple values, one value for each layer.

In one embodiment, an amplitude associated with the strongest RRH=1.

In one embodiment, the UE determines the CSI report including an indicator indicating an RRH selection in which Z out of the N_{RRH} RRHs are selected, wherein the CSI report is determined for the selected Z out of the N_{RRH} RRHs, and 1≤Z<N_{RRH}.

In one embodiment, the indicator indicating the RRH selection is a bit sequence b₁ . . . b_{N}_{_{RRH}} of length N_{RRH}, where bᵣ=0 indicates RRH r not selected, and bᵣ=1 indicates RRH r being selected.

In one embodiment, the indicator indicating the RRH selection is a

$$⌈ {log}_{2} ( \begin{matrix}{N}_{R R H} \\ Z\end{matrix} ) ⌉ bit$$

combinatorial indicator, wherein ┌┐ is a ceiling function.

In one embodiment, the indicator indicating the RRH selection indicates an amplitude value (aᵣ) for each RRH, where aᵣ=0 indicates that RRH r is not selected, and aᵣ>0 indicates that RRH r is selected.

In one embodiment, the RRH selection is reported as either layer-common or layer-specific, where the layer-common corresponds to a single value that is common for all layers and the layer-specific corresponds to multiple values, one value for each layer.

In one embodiment, the UE transmits the CSI report via a two-part uplink control information (UCI) comprising part 1 and part 2, and UCI part 1 includes information about the RRH selection.

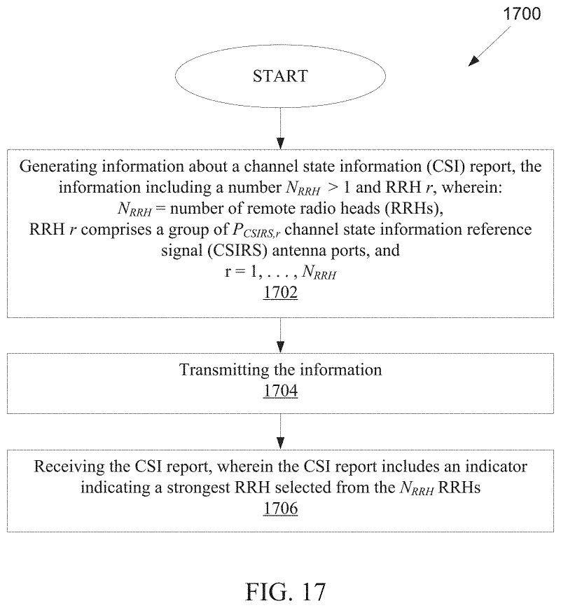

FIG. 17 illustrates a flow chart of another method 1700, as may be performed by a base station (BS) such as BS 102, according to embodiments of the present disclosure. The embodiment of the method 1700 illustrated in FIG. 17 is for illustration only. FIG. 17 does not limit the scope of this disclosure to any particular implementation.

As illustrated in FIG. 17, the method 1700 begins at step 1702. In step 1702, the BS (e.g., 101-103 as illustrated in FIG. 1), generates information about a channel state information (CSI) report, the information including a number N_{RRH}>1 and RRH r, wherein: N_{RRH}=number of remote radio heads (RRHs), RRH r comprises a group of P_{CSIRS,r} channel state information reference signal (CSIRS) antenna ports, and r=1, . . . , N_{RRH}.

In step 1704, the BS transmits the information.

In step 1706, the BS receives the CSI report, wherein the CSI report includes an indicator indicating a strongest RRH selected from the N_{RRH} RRHs.

In one embodiment, for each RRH r=1, . . . , N_{RRH}, the information includes an information about P_{CSIRS,r}.

In one embodiment, P_{CSIRS,r}=2N_{2,r} and the information about P_{CSIRS,r} corresponds to a value of (N_{1,r}, N_{2,r}).

In one embodiment, the strongest RRH is reported as either wideband (WB) or subband (SB), where WB corresponds to a single value that is common for all subbands in a CSI reporting band and SB corresponds to multiple values, one value for each subband in the CSI reporting band.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report, the information including a number N_{RRH}>1 and RRH r, wherein:
N_{RRH}=number of remote radio heads (RRHs),
RRH r comprises a group of P_{CSIRS,r} channel state information reference signal (CSIRS) antenna ports, and
r=1, . . . , N_{RRH}; and
a processor operably coupled to the transceiver, the processor, based on the information, configured to:
select a strongest RRH from the N_{RRH} RRHs; and
determine the CSI report including an indicator indicating the strongest RRH;
wherein the transceiver is configured to transmit the CSI report including the indicator indicating the strongest RRH.

2. The UE of claim 1, wherein for each RRH r=1, . . . N_{RRH}, the information includes an information about P_{CSIRS,r}.

3. The UE of claim 2, wherein P_{CSIRS,r}=2N_{1,r}N_{2,r} and the information about P_{CSIRS,r} corresponds to a value of (N_{1,r}, N_{2,r}).

4. The UE of claim 1, wherein the strongest RRH is reported as either wideband (WB) or subband (SB), where WB corresponds to a single value that is common for all subbands in a CSI reporting band and SB corresponds to multiple values, one value for each subband in the CSI reporting band.

5. The UE of claim 1, wherein the strongest RRH is reported as either layer-common or layer-specific, where the layer-common corresponds to a single value that is common for all layers and the layer-specific corresponds to multiple values, one value for each layer.

6. The UE of claim 1, wherein an amplitude associated with the strongest RRH=1.

7. The UE of claim 1, wherein the processor is further configured to determine the CSI report including an indicator indicating an RRH selection in which Z out of the N_{RRH} RRHs are selected, wherein the CSI report is determined for the selected Z out of the N_{RRH} RRHs, and 1≤Z<N_{RRH}.

8. The UE of claim 7, wherein the indicator indicating the RRH selection is a bit sequence b₁ . . . b_{N}_{_{RRH}} of length N_{RRH}, where bᵣ=0 indicates RRH r not selected, and bᵣ=1 indicates RRH r being selected.
$$⌈ {log}_{2} ( \begin{matrix}{N}_{R R H} \\ Z\end{matrix} ) ⌉ bit$$

9. The UE of claim 7, wherein the indicator indicating the RRH selection is a combinatorial indicator, wherein ┌┐ is a ceiling function.

10. The UE of claim 7, wherein the indicator indicating the RRH selection indicates an amplitude value (aᵣ) for each RRH, where aᵣ=0 indicates that RRH r is not selected, and aᵣ>0 indicates that RRH r is selected.

11. The UE of claim 7, wherein the RRH selection is reported as either layer-common or layer-specific, where the layer-common corresponds to a single value that is common for all layers and the layer-specific corresponds to multiple values, one value for each layer.

12. The UE of claim 7, wherein the transceiver is configured to transmit the CSI report via a two-part uplink control information (UCI) comprising part 1 and part 2, and UCI part 1 includes information about the RRH selection.

13. A base station (BS) comprising:
a processor configured to generate information about a channel state information (CSI) report, the information including a number N_{RRH}>1 and RRH r, wherein:
N_{RRH}=number of remote radio heads (RRHs),
RRH r comprises a group of P_{CSIRS,r} channel state information reference signal (CSIRS) antenna ports, and
r=1, . .. , N_{RRH}; and
a transceiver operably coupled to the processor, the transceiver configured to:
transmit the information; and
receive the CSI report,
wherein the CSI report includes an indicator indicating a strongest RRH selected from the N_{RRH} RRHs.

14. The BS of claim 13, wherein for each RRH r=1, . . . , N_{RRH}, the information includes an information about P_{CSIRS,r}.

15. The BS of claim 14, wherein P_{CSIRS,r}=2N_{1,r}N_{2,r} and the information about P_{CSIRS,r} corresponds to a value of (N_{1,r}, N_{2,r}).

16. The BS of claim 13, wherein the strongest RRH is reported as either wideband (WB) or subband (SB), where WB corresponds to a single value that is common for all subbands in a CSI reporting band and SB corresponds to multiple values, one value for each subband in the CSI reporting band.

17. A method for operating a user equipment (UE), the method comprising:
receiving information about a channel state information (CSI) report, the information including a number N_{RRH}>1 and RRH r, wherein:
N_{RRH}=number of remote radio heads (RRHs),
RRH r comprises a group of P_{CSIRS,r} channel state information reference signal (CSIRS) antenna ports, and
r=1, . . . , N_{RRH};
selecting a strongest RRH from the N_{RRH} RRHs;
determining the CSI report including an indicator indicating the strongest RRH; and
transmitting the CSI report including the indicator indicating the strongest RRH.

18. The method of claim 17, wherein for each RRH r=1,. . . , N_{RRH}, the information includes an information about P_{CSIRS,r}.

19. The method of claim 18, wherein P_{CSIRS,r}=2N_{1,r}N_{2,r} and the information about P_{CSIRS,r} corresponds to a value of (N_{1,r}, N_{2,r}).

20. The method of claim 17, further comprising reporting the strongest RRH as either wideband (WB) or subband (SB), where WB corresponds to a single value that is common for all subbands in a CSI reporting band and SB corresponds to multiple values, one value for each subband in the CSI reporting band.
